(19) United States
(12) Patent Application Publication
(10) Pub. No.: US 2010/0282179 A1
(43) Pub. Date: Nov. 11, 2010

(54) Combination-Type Pet Cage

(76) Inventor: YING-KUAN HO, TAINAN (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/437,591

(22) Filed: May 8, 2009

(51) Int. Cl. A01K 1/03

(52) U.S. Cl. 119/455; 119/474; 119/473

(57) ABSTRACT

A combination-type pet cage is constructed as follows. Two lateral panels are assembled to a base by inserting flanges and screw rod sections extended from lower ends of the lateral panels into corresponding slots and holes of the base. Then, a front panel and a rear panel are attached to the lateral panels by fitting receiving portions of the front and rear panels onto projections formed at front ends and rear ends of the lateral panels, so that flanges and screw rod sections extended from lower ends of the front and rear panels pass through corresponding slots and holes of the base. The lateral, front, and rear panels are secured in position to the base by wing nuts. Finally, a top panel is secured in position to upper ends of the lateral, front, and rear panels. Plural such pet cages are connectable and easily securable in position to one another.

### BACKGROUND OF THE INVENTION

1. Technical Field

The present invention relates to pet cages and, more particularly, to a combination-type pet cage for housing birds, wherein components of the combination-type pet cage are put together by an insertion process and are secured in position to one another by threaded fasteners that can be tightened without using tools, such that the pet cage is not only easily assembled, but can also be conveniently connected with additional components or another such pet cage.

2. Description of Related Art

Birdcages are commercially available in a variety of configurations and are assembled in many different ways. One common birdcage includes four lateral panels that are inserted into positionally corresponding grooves of a bottom panel and secured in position to the bottom panel by spaced-apart flanges. In addition, a top panel is assembled to the four lateral panels in such a way that a groove peripherally formed on a downward-facing surface of the top panel is fitted on upper ends of the four lateral panels so that the top panel is secured in position to the four lateral panels by spaced-apart flanges. After putting related components (such as an internal step board, a door panel, a water tray, and a feeding tray) in place, assembly of the birdcage is completed. However, as the birdcage has no specially designed features that allow further extension, the birdcage cannot be connected with additional components and thus has a fixed configuration.

### BRIEF SUMMARY OF THE INVENTION

In view of the invariable configurations of existing birdcages, the present invention aims to provide an improved pet cage whose components are put together by insertion and secured in position to one another by threaded fasteners that can be tightened without using tools, so as to form a structurally stable assembly. Besides, the pet cage features easy and secure connection with additional components.

A primary objective of the present invention is to provide a pet cage constructed in the following way. Two lateral panels are assembled to a base by inserting flanges and screw rod sections extended from lower ends of the lateral panels into positionally corresponding slots and holes of the base. Then, a front panel and a rear panel are attached to the lateral panels by downwardly fitting receiving portions which are formed on inward-facing edges of the front and rear panels onto spaced-apart projections formed at edges of front and rear ends of the lateral panels, so that flanges and screw rod sections extended from lower ends of the front and rear panels are inserted into positionally corresponding slots and holes of the base. Following that, the screw rod sections extended from the lateral, front, and rear panels are secured in position to the base by a plurality of wing nuts. Finally, a top panel is placed on and secured in position to upper ends of the lateral, front, and rear panels. Thus, by a simple insertion process, the pet cage is assembled into a stable structure that allows additional components to be conveniently connected with and secured in position to the pet cage.

A secondary objective of the present invention is to provide the foregoing pet cage, wherein a bottom panel is received in a peripheral frame formed on an inner periphery of the base and has an active surface concavely formed with at least two grooves corresponding in position and quantity to at least two grooves concavely formed on a downward-facing surface of the top panel. Thus, at least one solid partition and a hollow partition can be inserted slidably into and between the corresponding grooves on the bottom and top panels.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawings, wherein:

FIG. 1 is an exploded perspective view of a pet cage according to the present invention;

FIG. 1A and FIG. 1B are enlarged views of areas A and B in FIG. 1, respectively;

FIG. 2 is an assembled perspective view of the pet cage according to the present invention;

FIG. 3 is another perspective view of the pet cage according to the present invention, wherein a step board has been rotated outward;

FIG. 4 schematically shows installation of a plurality of partitions in the pet cage according to the present invention;

FIG. 5 shows an embodiment of how the partitions are positioned in the pet cage according to the present invention;

FIG. 6 shows another embodiment of how the partitions are positioned in the pet cage according to the present invention;

FIG. 7 schematically shows how the pet cage of the present invention is stacked on and connected with another such pet cage; and

FIG. 8 is another perspective view of the pet cage according to the present invention, wherein door panels are different from those shown in FIG. 2.

### DETAILED DESCRIPTION OF THE INVENTION

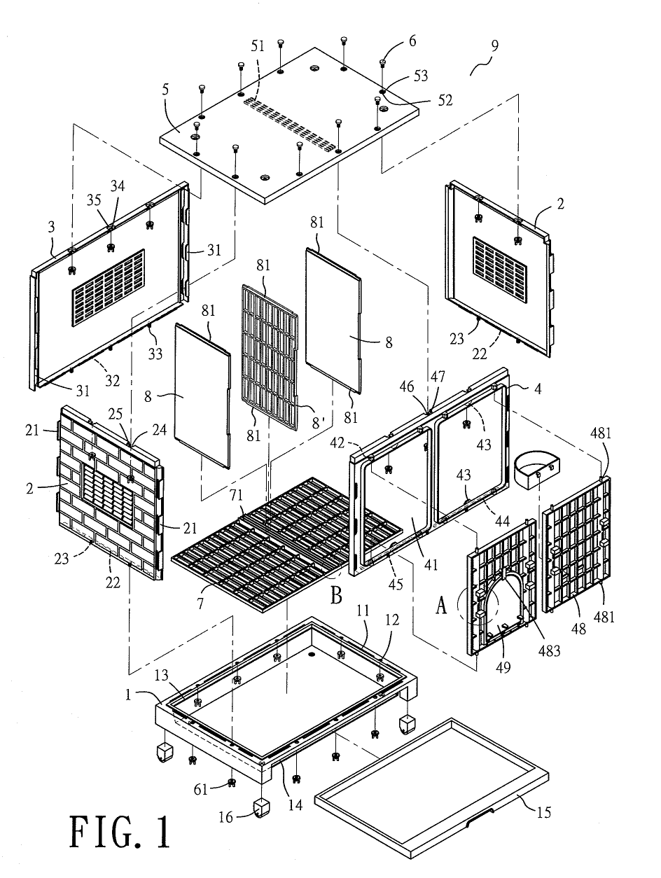

Referring to FIG. 1, a combination-type pet cage 9 according to the present invention includes a base 1, two lateral panels 2, a rear panel 3, a front panel 4, two door panels 48 assembled to the front panel 4, a top panel 5, a plurality of threaded fasteners 6 and wing nuts 61, a bottom panel 7, at least one solid partition 8, a hollow partition 8′, a water tray 15, and a plurality of casters 16.

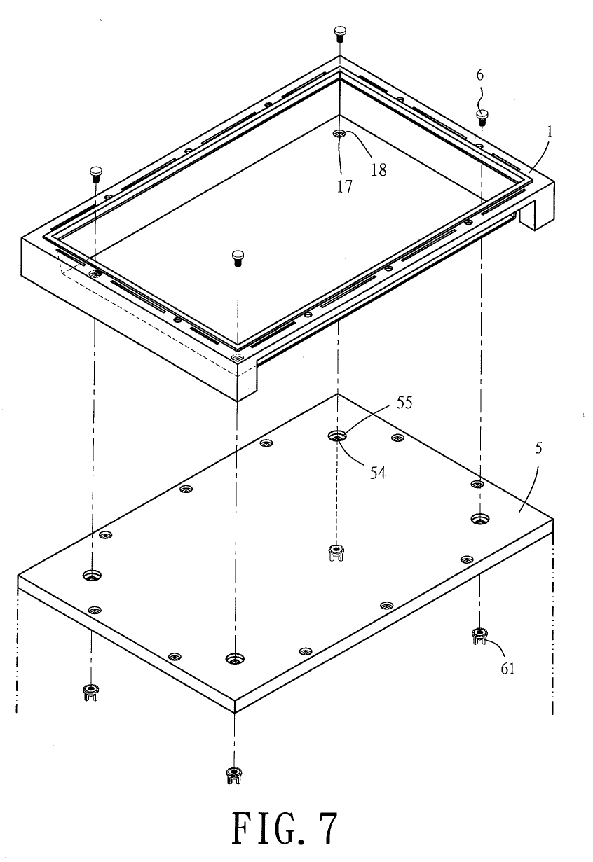

The base 1 is a concave component having a peripheral surface penetrated by a plurality of spaced-apart slots 11 and spaced-apart holes 12. A peripheral frame 13 is concavely formed on an inner periphery of the base 1. An opening 14 is formed at a lower portion of a front end of the base 1. At least one cavity 18 having a bore 17 therein is concavely provided on a bottom surface of the base 1, as shown in FIG. 7.

Each of the two lateral panels 2 has a front end and a rear end. One or more spaced-apart projections 21 are formed at an edge of each of the front and rear ends of the two lateral panels 2. At least one flange 22 and at least one screw rod section 23 are extended from a lower end of each of the two lateral panels 2. At least one cavity 25 having a bore 24 therein is concavely provided at an upper end of each of the two lateral panels 2.

The rear panel 3, which can be transparent or otherwise, has two lateral inward-facing edges each formed with one or more spaced-apart receiving portions 31. At least one flange 32 and at least one screw rod section 33 are extended from a lower end of the rear panel 3. At least one cavity 35 having a bore 34 therein is concavely provided at an upper end of the rear panel 3.

The front panel 4 is formed with two spaced-apart hollow spaces 41 each having an upper end and a lower end, wherein at least one cavity 42 and an inwardly positioned stop plate 43 are formed at each of the upper and lower ends. One or more spaced-apart receiving portions are formed on each of two lateral inward-facing edges of the front panel 4 and have the same configuration as the receiving portions 31 of the rear panel 3. At least one flange 44 and at least one screw rod section 45 are extended from a lower end of the front panel 4. At least one cavity 47 having a bore 46 therein is concavely provided at an upper end of the front panel 4.

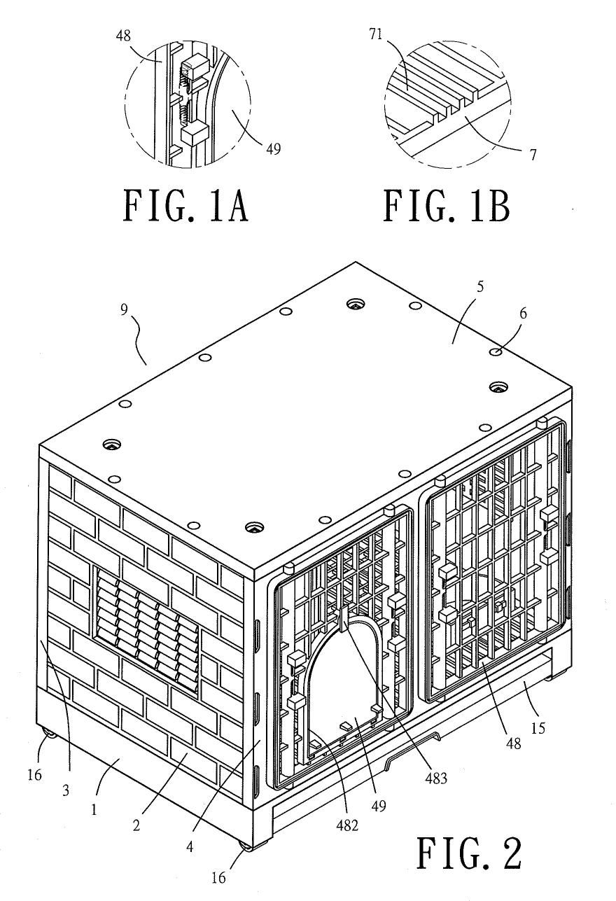

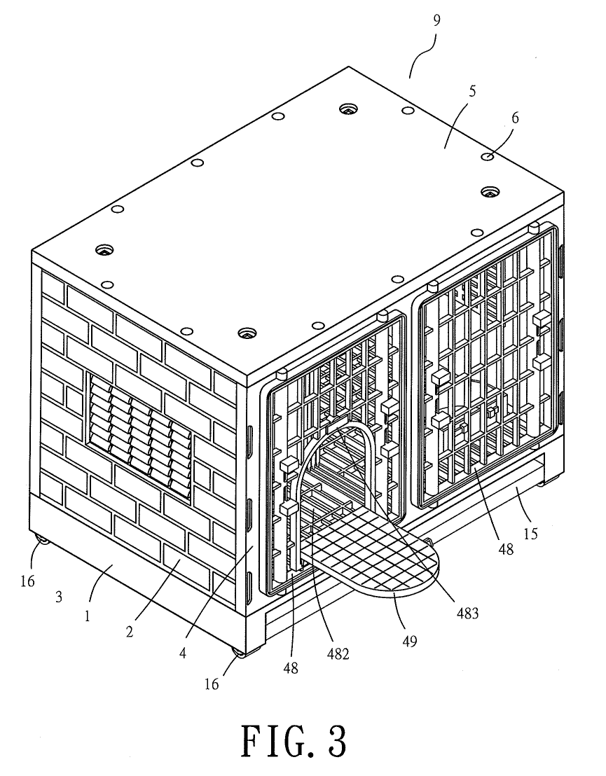

The two door panels 48 assembled to the front panel 4 are shaped according to the two spaced-apart hollow spaces 41 of the front panel 4. Each door panel 48 is bilaterally provided and penetrated by fastening rod sections 481 each having resiliently retractable upper and lower ends, thus enabling each door panel 48 to be installed in a corresponding one of the two hollow spaces 41 of the front panel 4, as shown in FIG. 2. One of the door panels 48 has a surface formed with a hollow space 482 pivotally provided with a step board 49 shaped according to the hollow space 482. More specifically, the step board 49 is installed in the hollow space 482 by means of protuberances bilaterally provided on the step board 49. The step board 49 can be rotated outward to an opened position, as shown in FIG. 3, and rotated inward to a closed position, as shown in FIG. 2, wherein the step board 49 has its upper end retained by a retainer 483 that has been rotated downward. The top panel 5 is a cover plate shaped according to a periphery jointly formed by the two lateral panels 2, the rear panel 3, and the front panel 4 assembled together. At least two grooves 51 are concavely provided on a downward-facing surface of the top panel 5. Besides, the top panel 5 is peripherally and concavely provided with cavities 53 each having a bore 52 therein. The bores 52 correspond in position and quantity to the bores 24, 34, 46 at the upper ends of the two lateral panels 2, the rear panel 3, and the front panel 4. Additionally, the top panel 5 is concavely provided with at least one cavity 55 having a bore 54 therein. The bores 54 correspond in position and quantity to the bores 17 on the bottom surface of the base 1, as shown in FIG. 7.

The bottom panel 7 is a mesh plate shaped according to the peripheral frame 13 formed on the inner periphery of the base 1. The bottom panel 7 has an active surface concavely provided with at least two grooves 71 corresponding in position and quantity to the at least two grooves 51 of the top panel 5.

Each solid partition 8 is a partitioning plate having a predetermined width and a height determined by the heights of the two lateral panels 2. Each solid partition 8 has an upper end and a lower end each formed with a projection 81, thus allowing the solid partitions 8 to be inserted slidably into and between the corresponding grooves 51 of the top panel 5 and the corresponding grooves 71 of the bottom panel 7.

The hollow partition 8′ is also a partitioning plate having a predetermined width and a height determined by the heights of the two lateral panels 2, but the hollow partition 8′ further has a hollow frame. Similar to the solid partitions 8, the hollow partition 8′ has an upper end and a lower end each formed with a projection 81, thus allowing the hollow partition 8′ to be inserted slidably into and between the corresponding groove 51 of the top panel 5 and the corresponding groove 71 of the bottom panel 7.

The water tray 15 is a tray configured so as to be inserted through the opening 14 at the lower portion of the front end of the base 1.

The plurality of casters 16 are installable at four corners of the base 1.

Referring to FIGS. 1 and 2, the abovementioned components are put together in the following manner. To begin with, the flanges 22 and the screw rod sections 23 extended from the lower end of each of the two lateral panels 2 are inserted into the positionally corresponding slots 11 and holes 12 of the base 1. Then, the receiving portions 31 formed at the inward-facing edges of the rear and front panels 3, 4 are downwardly fitted on the spaced-apart projections 21 formed at the edges of the front and rear ends of the two lateral panels 2, so that the flanges 32, 44 and the screw rod sections 33, 45 extended from the lower ends of the rear and front panels 3, 4 are inserted into the positionally corresponding slots 11 and holes 12 of the base 1. Next, the screw rod sections 23, 33, 45 of the lateral, rear, and front panels 2, 3, 4 are secured in position to the base 1 by a corresponding number of the wing nuts 61. Afterward, the top panel 5 is placed on the upper ends of the lateral, rear, and front panels 2, 3, 4 and secured in position by the threaded fasteners 6, which pass respectively through the corresponding bores 24, 34, 46, 54 of the panels 2, 3, 4, 5 and are fastened with the a corresponding number of the wing nuts 61 from below.

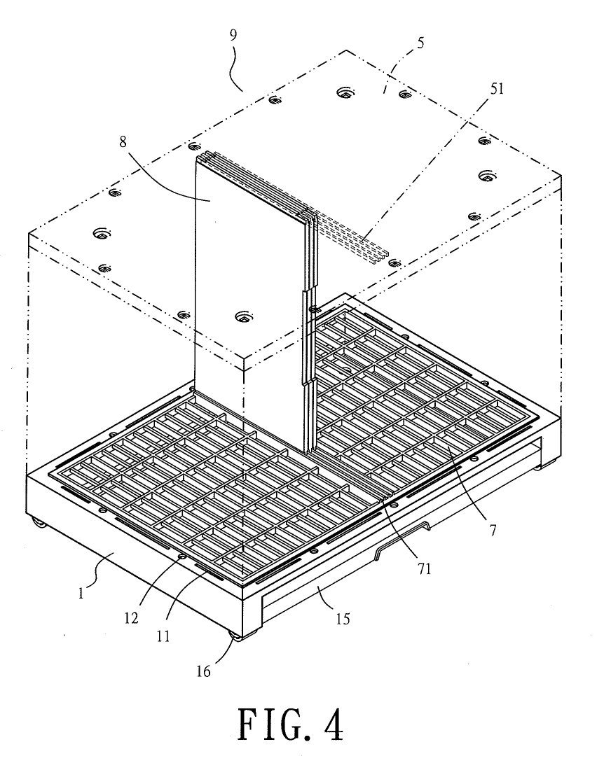

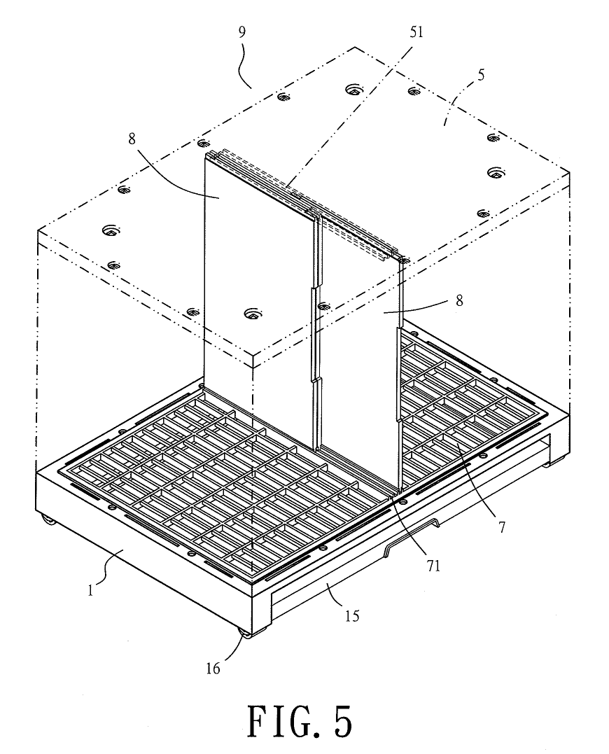

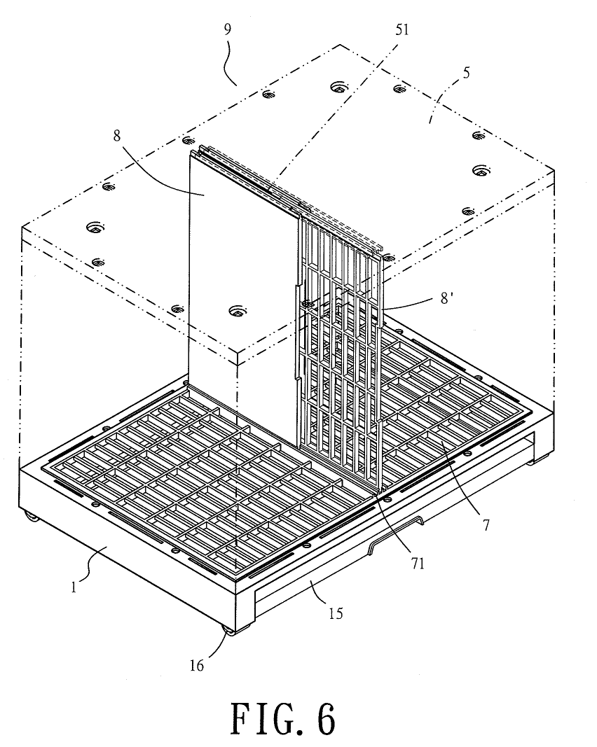

Then, as shown in FIG. 4, the bottom panel 7 is fitted into the peripheral frame 13 formed on the inner periphery of the base 1. The solid partitions 8 and the hollow partition 8′ are subsequently inserted into and between the corresponding grooves 51, 71 of the top and bottom panels 5, 7. The solid partitions 8 and the hollow partition 8′ can be slid to appropriate positions, as shown in FIGS. 5 and 6. Thus, assembly of the pet cage 9 is completed by a simple insertion process.

Referring to FIG. 7, when it is desired to connect the pet cage 9 with another such pet cage 9, one on top of the other, the base 1 of the upper pet cage 9 is placed on the top panel 5 of the lower pet cage 9, allowing the threaded fasteners 6 to penetrate respectively the corresponding bores 17, 54 in the cavities 18, 55 of the base 1 and of the top panel 5. After the wing nuts 61 are connected with the threaded fasteners 6 and tightened up, the upper and lower pet cages are secured in position to each other and form a two-story assembly. A more-than-two-story assembly can be formed in a similar way.

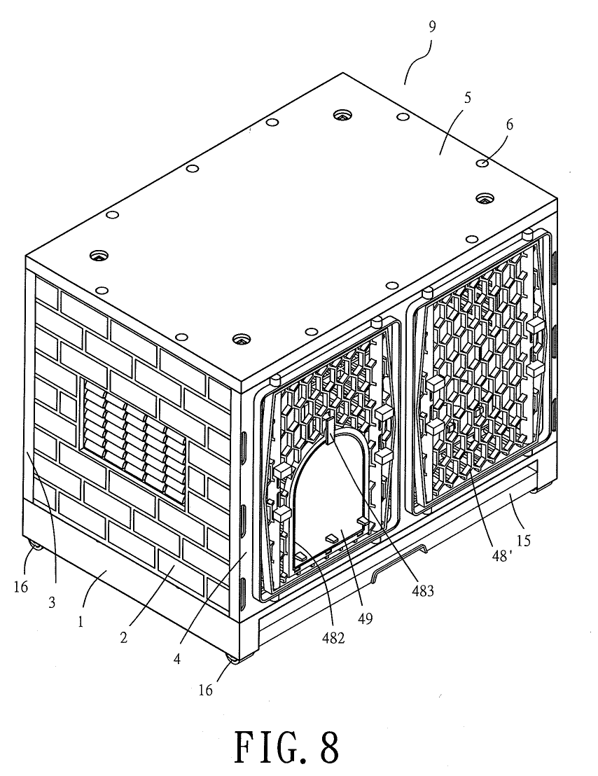

Moreover, the two door panels 48 assembled to the front panel 4 may have a plurality of rectangular openings, as shown in FIG. 2, or a plurality of hexagonal openings, as illustrated by door panels 48′ in FIG. 8.

The pet cage according to the present invention provides the following advantages:

1. When assembled together, the components of the pet cage are secured in position to one another so that the assembled pet cage has a stable structure.

2. When it is desired to form a two-story or more-than-two-story assembly with a plurality of the pet cages stacked together, it can be easily done by adjoining corresponding components of each two adjacent pet cages and then passing the threaded fasteners through the corresponding bores of the adjoining components so as to secure the stacked pet cages in position to one another.

3. The partitions of the pet cage can be slid to desired positions so as to form one or more connected or separate compartments.

4. The rear panel of the pet cage may be transparent or have a see-through structure so as to facilitate observation of pets inside the pet cage.

1. A combination-type pet cage, comprising:
a base having a peripheral surface penetrated by a plurality of spaced-apart slots and spaced-apart holes;
two lateral panels each having a front end and a rear end, wherein one or more spaced-apart projections are formed at an edge of each said front end and of each said rear end while at least a flange and at least a screw rod section are extended from a lower end of each said lateral panel so as to pass through respectively a positionally corresponding at least one said slot of the base and a positionally corresponding at least one said hole of the base such that each said screw rod section of the lateral panels has an end jutting out of the positionally corresponding hole of the base and fastened with a wing nut, wherein each said lateral panel has an upper end concavely provided with at least a cavity having a bore therein;
a rear panel having two lateral inward-facing edges each formed with one or more spaced-apart receiving portions to be fitted downwardly and respectively on the one or more projections formed at the edge of the rear end of each said lateral panel, wherein at least a flange and at least a screw rod section are extended from a lower end of the rear panel so as to pass through respectively a positionally corresponding at least one said slot of the base and a positionally corresponding at least one said hole of the base such that each said screw rod section of the rear panel has an end jutting out of the positionally corresponding hole of the base and fastened with a wing nut, wherein the rear panel has an upper end concavely provided with at least a cavity having a bore therein;
a front panel having two lateral inward-facing edges each formed with one or more spaced-apart receiving portions to be fitted downwardly and respectively on the one or more projections formed at the edge of the front end of each said lateral panel, wherein at least a flange and at least a screw rod section are extended from a lower end of the front panel so as to pass through respectively a positionally corresponding at least one said slot of the base and a positionally corresponding at least one said hole of the base such that each said screw rod section of the front panel has an end jutting out of the positionally corresponding hole of the base and fastened with a wing nut, wherein the front panel has an upper end concavely provided with at least a cavity having a bore therein; and
a top panel peripherally and concavely provided with cavities each having a bore therein, wherein the bores of the top panel correspond in position and quantity to the bores at the upper ends of the lateral, rear, and front panels, thus allowing a plurality of threaded fasteners to pass through respectively the corresponding bores of the top, lateral, rear, and front panels and be fastened with wing nuts from below;
wherein the pet cage is easily assembled into a stable structure which allows related components to be conveniently connected with and secured in position to the pet cage.

2. The combination-type pet cage of claim 1, wherein the base has an inner periphery formed with a peripheral frame for receiving a bottom panel having an active surface concavely provided with at least two grooves corresponding in position and quantity to at least two grooves concavely provided on a downward-facing surface of the top panel so that at least a solid partition and a hollow partition can be inserted slidably in and between corresponding ones of the at least two grooves of the base and corresponding ones of the at least two grooves of the top panel.

3. The combination-type pet cage of claim 1, wherein the base has a bottom surface concavely provided with at least a cavity having a bore therein while the top panel is concavely provided with at least a second cavity having a second bore therein, the at least a bore of the base corresponding in position and quantity to the at least a second bore of the top panel, wherein when plural said pet cages are to be stacked and connected together, the base of an upper said pet cage is placed on the top panel of a lower said pet cage, thus allowing at least a threaded fastener to pass through the at least a bore of the base of the upper said pet cage and the at least a second bore of the top panel of the lower said pet cage and be fastened with at least a wing nut, respectively, thereby securing the plural said pet cages in position to one another.
